(19) United States
(12) Patent Application Publication
(10) Pub. No.: US 2002/0002659 A1
(43) Pub. Date: Jan. 3, 2002

(54) SYSTEM AND METHOD FOR IMPROVING DIRECTORY LOOKUP SPEED

(76) Inventors: MAGED MILAD MICHAEL, DANBURY, CT (US); ASHWINI KUMAR NANDA, MOHEGAN LAKE, NY (US)

Correspondence Address: DAVID M SHOFI, IBM CORPORATION, PO BOX 218, YORKTOWN HGTS, NY, 10598

(21) Appl. No.: 09/087,094

(22) Filed: May 29, 1998

(51) Int. Cl. G06F 12/08

(52) U.S. Cl. 711/141; 711/119; 711/104; 711/3

(57) ABSTRACT

A system and method of maintaining consistent cached copies of memory in a multiprocessor system having a main memory, includes a memory directory having entries mapping the main memory and a directory cache having records corresponding to a subset of the memory directory entries. The memory directory is preferably a full map directory having entries mapping all of the main memory or a sparse directory having entries mapping to a subset of the main memory. The method includes the steps of receiving, at the coherence controller, a signal indicative of a processor cache miss or a coherence request associated with a memory line in one of the plurality of compute nodes; determining a target coherence controller from the signal; performing a directory lookup in a directory cache of a compute node associated with the targeted coherence controller to determine a state of the memory line in each cache of the system.

### FIELD OF THE INVENTION

The present invention relates to efficient processing of memory requests in cache-based systems. More specifically, the present invention relates to improved processing speed of memory requests (or other coherence requests) in the coherence controller of shared memory multiprocessor servers or in the cache controller of uniprocessor systems.

### BACKGROUND

Conventional computer systems often include on-chip or off-chip cache memories which are used with processors to speed up accesses to system memory. In a shared memory multiprocessor system, more than one processor can store a copy of the same memory locations (or lines) in the respective cache memories. A cache coherence mechanism is required to maintain consistency among the multiple cached copies of the same memory line. In small, bus-based multiprocessor systems, the coherence mechanism is usually implemented as a part of the cache controllers using a snoopy coherence protocol. The snoopy protocol cannot be used in large systems that are connected through an interconnection network due to the lack of a bus. As a result, these systems use a directory-based protocol to maintain cache coherence. The directories are associated with the main memory and maintain the state information of the various caches on the memory lines. This state information includes data indicating which cache(s) has a copy of the line or whether the line has been modified in a cache(s).

Conventionally, these directories are organized as “full map” memory directories where the state information on every single memory line is stored by mapping each memory line to a unique location in the directory. FIG. 1 illustrates a representation of this arrangement. The memory directory 100 for main memory 120 is provided. In this implementation, entries 140 of the main directory 100 include state information for each memory line 160 of main memory 120. That is, there is a one to one (state) mapping between a main memory line 160 and a memory directory entry 140. As a result, when the size of main memory 120 increases, the memory directory 100 size also increases. If the memory directory 100 is implemented as relatively fast static RAM, tracking the size of main memory 120 becomes prohibitively expensive. If the memory directory 100 is implemented using slow static RAMs or DRAMs, higher cost is avoided. However, a penalty is incurred in overall system performance due to the slower chips. In fact, each directory access in such implementations will take approximately 5-20 controller cycles to complete.

In order to address this problem, “sparse” memory directories have been used in place of the (“full map”) memory directories. FIG. 2 shows a representation of this arrangement. A sparse directory 200 is smaller in size than the memory directory 100 of FIG. 1 and is organized as a subset of the memory directory 100. The sparse directory 200 includes state information entries 240 for only a subset of the memory lines 260 of main memory 220. That is, multiple memory lines are mapped to a location in the sparse directory 200. Thus, due to its smaller size, a sparse directory 200 can be implemented in an economical fashion using fast static RAMs. However, when there is contention among memory lines 260 for the same sparse directory entry field 240, the state information of one of the lines 260 must be replaced. Since there is no backup state information, when a line 260 is replaced from the sparse directory 200, all the caches in the overall system having a copy of that line must be asked to invalidate their copies. This incomplete directory information leads to both coherence protocol complexity and performance loss.

Thus, there is a need for a system which improves coherence/caching efficiency without adversely affecting overall system performance and maintains a relatively simple coherence protocol environment.

Caches (and their respective directories) of both uniprocessor and multiprocessor systems are also growing in size with the growth of memory size. As these caches continue to grow, the use of fast static RAM will become less practical, considering the added cost.

Thus, there is also a need for a system which improves caching efficiency without impractically increasing costs.

### SUMMARY OF THE INVENTION

In accordance with the aforementioned needs, the present invention provides a system and method for improving the speed of directory lookups in systems which utilize single or multiple cache memories. In one embodiment, the system uses a high speed directory cache (DC), located off-chip or on the coherence controller chip, in association with a conventional memory directory. While access to the memory directory can take approximately 5-20 cycles in typical implementations, access to the DC can take only one (1) controller cycle latency. Thus, the DC can be accessed at a fraction of the memory directory latency. Since the DC captures the most frequently used directory entries due to both temporal and spatial locality, most of the directory accesses can be satisfied by the faster DC. Furthermore, whenever there is a DC miss, the information can still be obtained from the memory directory. This fall back is not provided in the case of either the full map memory directory or the sparse directory. Therefore, both performance penalty and protocol complexity are avoided.

In communication intensive applications, use of the DC of the present invention can result in 40% or more improvement in execution time. In fact, the DC can result in 40% or more performance gain in terms of total program execution time compared to a full map memory directory-only solution using DRAMs 10 times slower than the DC. If the DRAMs are 15 times slower, the performance improvement could be 65% or more. As DRAMs get slower and slower compared to logic chips, this performance advantage becomes more pronounced.

Specifically, one embodiment of the present invention provides a system for maintaining consistent cached copies of memory in a multiprocessor system having a main memory, including a memory directory having entries mapping the main memory and a directory cache having records corresponding to a subset of the memory directory entries. The memory directory is preferably a full map directory having entries mapping all of the main memory or a sparse directory having entries mapping to a subset of the main memory.

In a preferred embodiment, the multiprocessor system also has a more than one coherence controller subsystem and the directory cache is disposed in or controlled by each of the coherence controller subsystems.

The subset of the memory directory entries preferably corresponds to a set of most frequently used memory directory entries. The directory cache is preferably implemented with static RAM.

Another embodiment of the system of the present invention incorporates the DC in association with a conventional cache (and corresponding cache directory). Specifically, this embodiment provides a cache subsystem of a computer system having a memory, comprising a cache having data corresponding to portions of the memory, a cache directory having entries mapping state information of the data, and a directory cache having records corresponding to a subset of the state information.

Preferably, the cache subsystem further has a cache controller subsystem and the directory cache is disposed in or controlled by the cache controller subsystem. The directory cache is also preferably implemented with static RAM.

The present invention also provides a method of performing a directory lookup in a system having a main memory, a plurality of compute nodes, each having a coherence controller, a processor cache, a memory directory of the main memory and a directory cache of the memory directory, the method including the steps of receiving, at the coherence controller, a signal indicative of a processor cache miss or a coherence request associated with a memory line in one of the plurality of compute nodes; determining a target coherence controller from the signal, performing a directory lookup in a directory cache of a compute node associated with the targeted coherence controller to determine a state of the memory line in each cache of the system.

The determining step preferably includes the steps of identifying a responsible coherence controller and presenting the signal to the responsible coherence controller. The presenting step preferably comprises the step of routing the signal to a remote compute node.

The performing step preferably includes the steps of reading directory information from the directory cache and forwarding the directory information to an associated coherence controller for coherence action.

Preferably, the method further includes the steps of determining a directory cache miss and requesting information from an associated memory directory responsive to the determining step. The method then further includes the step of updating the directory cache responsive to the requesting step.

The present invention also provides a method of performing a cache lookup in a system including the steps of receiving, in the directory cache, a disk or memory request and performing a directory lookup on the directory cache to determine a state of a disk space or memory line corresponding to the disk or memory request, respectively.

This method further includes the steps of determining a directory cache miss and requesting information from the cache directory responsive to the determining step. It is also preferable that the method further include the step of updating the directory cache responsive to the requesting step.

Finally, the present invention provides a program storage device, readable by a machine, tangibly embodying a program of instructions executable by the machine to perform method steps for implicitly localizing agent access to a network component according to the method steps listed hereinabove.

### BRIEF DESCRIPTION OF THE DRAWINGS

These and other features of the present invention will become apparent from the accompanying detailed description and drawings, wherein:

FIG. 1 shows an example of a conventional memory directory system;

FIG. 2 shows an example of a conventional sparse directory system;

FIG. 3 shows an example of a system environment incorporating the directory cache of the present invention;

FIG. 4 shows one embodiment of the present invention;

FIG. 5 shows an implementation of the directory cache of the present invention;

FIG. 6 shows a representation of a line address of the directory cache of FIG. 5;

FIG. 7 shows the operation of one embodiment of the directory cache of the present invention; and

FIG. 8 shows another embodiment of the present invention.

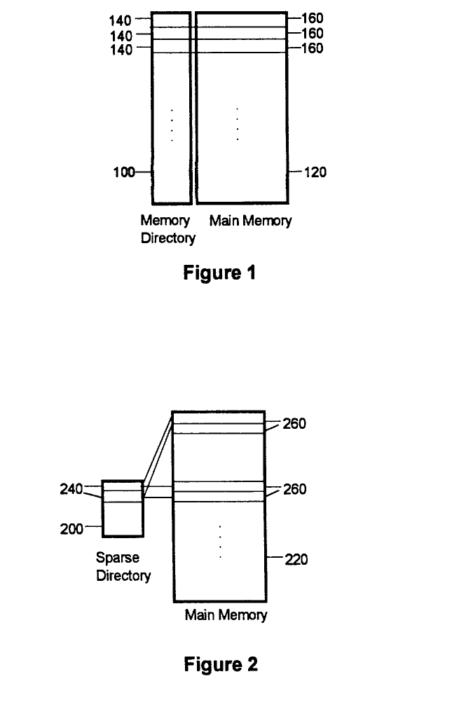

### DETAILED DESCRIPTION

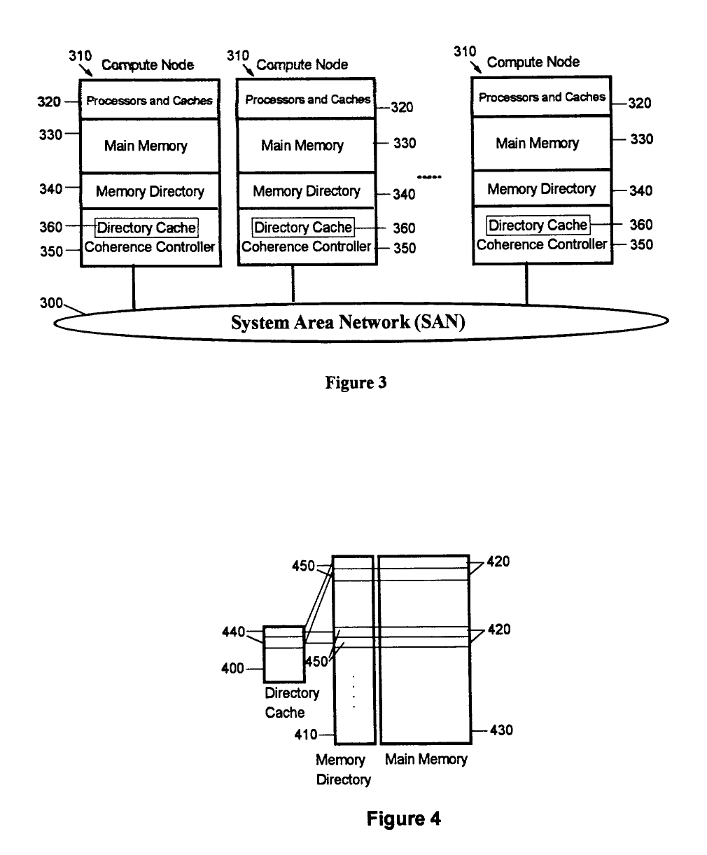

FIG. 3 depicts a multiprocessor system environment in which the directory cache (DC) of the present invention can be implemented. On a system area network (SAN) 300, one or more compute nodes 310 exist. Each compute node includes one or more processors with associated caches 320, one or more main memory modules 330, at least one memory directory 340, at least one coherence controller 350 and several I/O devices (not shown). One skilled in the art will appreciate that memory for a compute node can be located in separate modules independent of the compute node. In that case, the coherence controller and the DC can be disposed with the memory or the processor. Preferably, a DC 360 is disposed within the coherence controller's functionality, as shown in FIG. 3. The coherence controllers 350 (implemented in hardware or software) are responsible for maintaining coherence among the caches in the compute nodes 310.

FIG. 4 shows an embodiment of the present invention utilizing the DC. In contrast to the conventional arrangements of the prior art, the present invention utilizes a memory directory 410 as a backup for the state information on all the memory lines 420 of the main memory 430. While, in this embodiment, the memory directory 410 is illustrated as a full map directory, the DC of the present invention can also be used to improve the performance of systems utilizing directories other than the full map memory directories, e.g. sparse directories. The DC 400, as described hereinbelow, is organized as a cache and stores the state information of only the most frequently used lines 450 of the memory directory 410. When there is a replacement from the DC 440, the state information is written back into the memory directory 410 without the need to invalidate all the corresponding cache lines in the overall system. Thus, the state information on the cache lines represented by the DC entry being replaced will be available in the memory directory for future use.

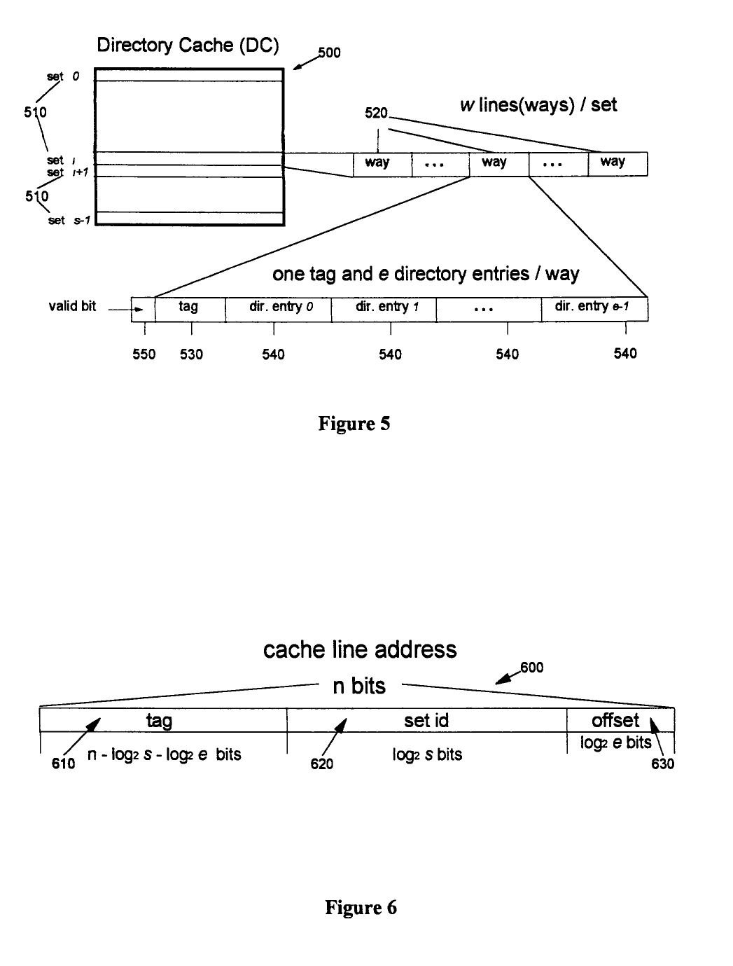

FIG. 5 shows an implementation of the DC of the present invention. The DC 500 contains s sets 510. Each set consists of w DC lines 520 corresponding to the w ways of associativity. Each DC line 520 contains a tag 530 and e directory entries 540. As shown in FIG. 4, the structure of a DC is similar to a conventional set associative cache except that, in each DC line, a set of directory entries are cached instead of a set of memory words. A typical formula for the total DC size in bits is: {(s) (w) (1+tag size+(e) (dir entry size))}. The values of s, w and e, are typically powers of 2.

The address input to the DC 500 is the component of a memory address that identifies a cache line (cache line address). As shown in FIG. 6, for an n bit cache line address 600, the tag 610 is the most significant (n−log₂s−log₂e) bits, the set is identified (with set id 620) by the next log₂s bits, and the offset 630 of the requested directory entry, if present in any of the w ways in the set, is identified by the least significant log₂e bits.

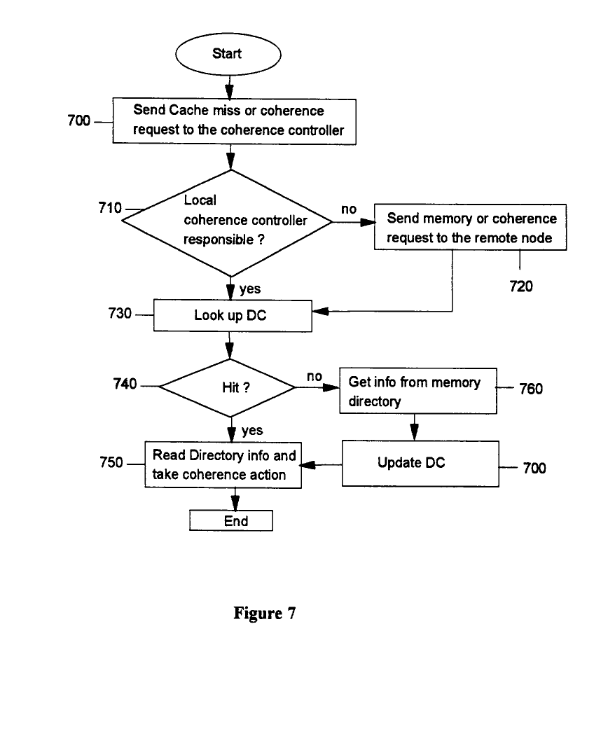

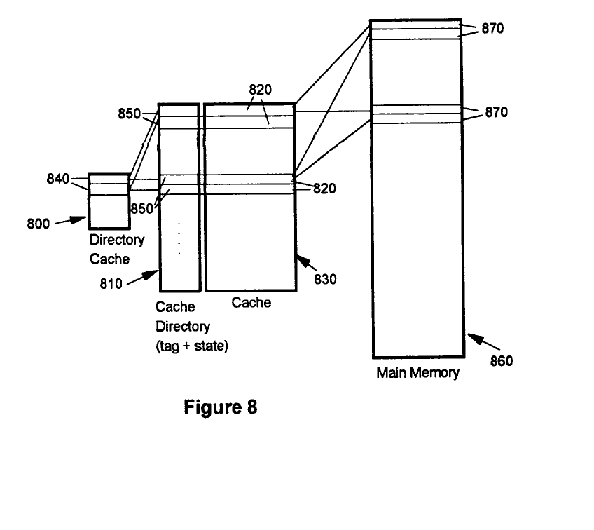

FIG. 7 illustrates the operation of an embodiment of the present invention. When a cache miss occurs in one of the processor's caches or a coherence request is otherwise made (such as occurs after a write to a shared memory line) in a compute node 310, a signal indicative of the miss or the coherence request (such as occurs after a write to a shared memory line) is presented to the coherence controller 350 in step 700. If the memory address, in step 710, is determined to correspond to a memory module for which the local coherence controller is not responsible, the memory request is routed through the SAN 300 to the corresponding remote coherence controller in step 720. Thereafter, a DC lookup is executed in step 730 at the remote node. If, however, the local coherence controller is determined, in step 710, to be responsible for the memory address, the process continues directly to step 730 where a lookup on the DC is executed locally. In step 740, a hit determination is made. If there is a hit in the DC, the corresponding directory information is read and the required coherence action is taken by the coherence controller, in step 750. If a hit is not detected in step 740, the requested information is acquired from the memory directory in step 760. In step 770, the DC is updated. Finally, the process continues in step 750 as described hereinabove.

More specifically, the set id 620 is used to obtain the contents of the corresponding set in the DC 500. The tag 610 is compared with each of the w tags stored in the w ways 520 of the set 510. If the tag 610 matches a valid (indicated by the valid bit 550) way 520, the offset field 630 determines the exact directory entry in the matching DC line to be returned as output. If the tag 610 of the current memory address does not match any of the stored tags, the coherence controller 350 requests the necessary information from the memory directory. If one or more of the ways 520 in the set 510 are invalid, one of them is filled with the tag and the information obtained from the memory directory. If none of the ways 520 is invalid, one of them is selected and its contents are written to the memory directory, if necessary, and replaced by the new tag and directory entries from the memory directory.

In order to achieve about 90% hit ratio, the DC cache preferably has approximately 1K entries (or 2K bytes in an 8-node system) for technical applications and about 8K entries (or 16K bytes in a 8-node system) for commercial applications. Directory caches of these sizes can be easily incorporated into the coherence controller chips. Alternatively, the directory cache can also be implemented as an off-chip entity with zero or more extra clock cycles latency, or a combination of large off-chip DC and a small, fast on-chip DC. In any case, the DC can be implemented using fast static RAMs due to its relatively small size.

The DC of the present invention can be applied to the processor cache of a uniprocessor as well as a multiprocessor. FIG. 8 shows this embodiment of the invention. In this embodiment, a DC 800 is provided with a cache directory 810 of a cache 830 of an individual processor (not shown). The DC 800 includes entries 840 corresponding to a subset of the cache directory entries 850 which contain the tag and state information of the cache entries 820. The cache entries 820, in turn, contain a subset of the data located in the memory line entries 870 of the main memory 860.

In this embodiment, caching speed of a single processor cache (whether in a uniprocessor or multiprocessor system) is increased substantially by using the DC 800 of the present invention. Rather than providing control of the DC 800 in a coherence controller as in the embodiment of FIG. 4, control resides in the cache controller (not shown) in this embodiment. For instance, when a DC miss occurs, the cache controller requests the necessary information from the cache 830. Otherwise, the system of FIG. 8 functions as described hereinabove with the cache directory substituted for the memory directory.

Now that the invention has been described by way of a preferred embodiment, various modifications and improvements will occur to those of skill in the art. For instance, the DC can also be used with a cache for a disk system which could benefit from its efficiency characteristics. Thus, it should be understood that the preferred embodiment is provided as an example and not as a limitation. The scope of the invention is defined by the appended claims.

We claim:

1. A system for maintaining consistent cached copies of memory in a multiprocessor system having a main memory, comprising:
a memory directory having entries mapping the main memory; and
a directory cache having records corresponding to a subset of the memory directory entries.

2. The system of claim 1 wherein the memory directory is a full map directory having entries mapping all of the main memory.

3. The system of claim 1 wherein the memory directory is a sparse directory having entries mapping to a subset of the main memory.

4. The system of claim 1 wherein the multiprocessor system further has a plurality of coherence controller subsystems and wherein the directory cache is disposed in or controlled by each of the plurality of coherence controller subsystems.

5. The system of claim 1 wherein the subset of the memory directory entries corresponds to a set of most frequently used memory directory entries.

6. The system of claim 1 wherein the directory cache is implemented with a fast memory faster than that of the memory directory.

7. The system of claim 1 wherein the directory cache is implemented with static RAM.

8. A cache subsystem of a computer system having a memory, comprising:
a cache having data corresponding to portions of the memory;
a cache directory having entries mapping state information of the data; and
a directory cache having records corresponding to a subset of the state information.

9. The system of claim 8 wherein the cache subsystem further has a cache controller subsystem and wherein the directory cache is disposed in or controlled by the cache controller subsystem.

10. The system of claim 8 wherein the directory cache is implemented with a fast memory faster than that of the cache memory.

11. The system of claim 8 wherein the directory cache is implemented with static RAM.

12. A method of performing a directory lookup in a system having a main memory, a plurality of compute nodes, each having a coherence controller, a processor cache, a memory directory of the main memory and a directory cache of the memory directory, the method comprising the steps of:
receiving, at the coherence controller, a signal indicative of a processor cache miss or a coherence request associated with a memory line in one of the plurality of compute nodes;
determining a target coherence controller from the signal;
performing a directory lookup in a directory cache of a compute node associated with the targeted coherence controller to determine a state of the memory line in each cache of the system.

13. The method of claim 12 wherein the determining step comprises the steps of:
identifying a responsible coherence controller; and
presenting the signal to the responsible coherence controller.

14. The method of claim 13 wherein the presenting step comprises the step of routing the signal to a remote compute node.

15. The method of claim 12 wherein the performing step comprises the steps of:
reading directory information from the directory cache; and
forwarding the directory information to an associated coherence controller for coherence action.

16. The method of claim 12 further comprising the steps of:
determining a directory cache miss; and
requesting information from an associated memory directory responsive to the determining step.

17. The method of claim 16 further comprising the step of updating the directory cache responsive to the requesting step.

18. A method of performing a cache lookup in a system comprising:
receiving, in the directory cache, a disk or memory request;
performing a directory lookup on the directory cache to determine a state of a disk space or memory line corresponding to the disk or memory request, respectively.

19. The method of claim 18 further comprising the steps of:
determining a directory cache miss; and
requesting information from the cache directory responsive to the determining step.

20. The method of claim 19 further comprising the step of updating the directory cache responsive to the requesting step.

21. A program storage device, readable by a machine, tangibly embodying a program of instructions executable by the machine to perform method steps for implicitly localizing agent access to a network component according to the method steps of claim 12.

22. A program storage device, readable by a machine, tangibly embodying a program of instructions executable by the machine to perform method steps for implicitly localizing agent access to a network component according to the method steps of claim 18.
